(19) United States
(12) Patent Application Publication
(10) Pub. No.: US 2011/0091096 A1
(43) Pub. Date: Apr. 21, 2011

(54) Real-Time Stereo Image Matching System

(75) Inventors: John Mackinnon Morris, Auckland (NZ); Georgy Lvovich Gimel'Farb, Auckland (NZ)

(73) Assignee: Auckland UniServices Limited, Auckland (NZ)

(21) Appl. No.: 12/990,759

(22) PCT Filed: May 4, 2009
(86) PCT No.: PCT/NZ09/00068

§ 371 Date: Dec. 22, 2010

(30) Foreign Application Priority Data
May 2, 2008 (NZ) 567986

(51) Int. Cl. G06K 9/00

(52) U.S. Cl. 382/154

(57) ABSTRACT

A real-time stereo image matching system for stereo image matching of a pair of images captured by a pair of cameras (12, 14). The system may be in the form of a computer expansion card (10) for running on a host computer (11). The computer expansion card comprises an external device interface (16) for receiving the image pixel data (13, 15) of the pair of images from the cameras and a hardware device (20) having logic that is arranged to implement a symmetric dynamic programming stereo matching algorithm for generating disparity map data (26) for the host computer (11).

### FIELD OF THE INVENTION

The present invention relates to a stereo image matching system for use in imaging applications that require ‘real-time’ 3D information from stereo images, and in particular high resolution images.

### BACKGROUND TO THE INVENTION

It is well known that stereo vision can be used to extract 3D information about a scene from images captured from two different perspectives. Typically, stereo vision systems use stereo matching algorithms to create a disparity map by matching pixels from the two images to estimate depth for objects in the scene. Ultimately, image processing can convert the stereo images and disparity map into a view of the scene containing 3D information for use by higher level programs or applications.

The stereo matching exercise is generally slow and computationally intensive. Known stereo matching algorithms generally fall into two categories, namely local and global. Global algorithms return more accurate 3D information but are generally far too slow for real-time use. Local algorithms also fall into two main categories, namely correlation algorithms which operate over small windows and dynamic programming algorithms which are local to a scan line, each offering a trade-off between accuracy, speed and memory required. Correlation algorithms tend to use less memory but are inaccurate and slower. Dynamic programming algorithms tend to be faster and are generally considered to provide better matching accuracy than correlation algorithms, but require more memory.

Many stereo matching algorithms have been implemented in software for running on a personal computer. Typically, it can take between a few seconds to hours for a personal computer to process a single pair of high resolution stereo images. Such long processing times are not suited to stereo vision applications that require real-time 3D information about a scene.

Real-time stereo vision systems tend to use dedicated hardware implementations of the matching algorithms to increase computational speeds. Because most reconfigurable hardware devices, such as Programmable Logic Devices (PLDs), do not have an abundance of internal memory, correlation matching algorithms have been preferred for hardware implementation for real-time systems. However, such systems still often lack the speed and matching performance required for the real-time applications that need fast, detailed and accurate 3D scene information from high resolution stereo images.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

It is an object of the present invention to provide an improved real time stereo image matching system, or to at least provide the public with a useful choice.

### SUMMARY OF THE INVENTION

In a first aspect, the present invention broadly consists in a hardware device for stereo image matching of a pair of images captured by a pair of cameras comprising: an input or inputs for receiving the image pixel data of the pair of images; logic that is arranged to implement a Symmetric Dynamic Programming Stereo (SDPS) matching algorithm, the SDPS matching algorithm being arranged to process the image pixel data to generate disparity map data; memory for at least a portion of the algorithm data processing; and an output or outputs for the disparity map data.

Preferably, the hardware device further comprises logic that is arranged to implement a distortion removal algorithm and/or an alignment correction algorithm on the image pixel data prior to processing by the SDPS matching algorithm.

Preferably, the hardware device further comprises logic that is arranged to implement a data conversion algorithm that converts the disparity map data generated by the SDPS matching algorithm into depth map data for the output(s).

Preferably, the SDPS matching algorithm is arranged to calculate an optimal depth profile for corresponding pairs of scan lines of the image pixel data. More preferably, the SDPS matching algorithm is arranged to generate disparity map data based on a virtual Cyclopaean image that would be seen by a single camera situated midway between the pair of cameras, such as left and right cameras.

Preferably, the SDPS matching algorithm is arranged to generate disparity map data for each pixel in the Cyclopaean image, scan line by scan line.

Preferably, the pair of cameras comprise a left camera and a right camera, and the SDPS matching algorithm is arranged to select one of the three visibility states for each pixel in the Cyclopaean image, the visibility states comprising: ML—monocular left in which the pixel is visible by the left camera only, B—binocular in which the pixel is visible by both cameras, and MR—monocular right in which the pixel is visible by the right camera only.

Preferably, the disparity map data generated by the SDPS matching algorithm comprises a disparity value for each pixel in the Cyclopaean image, and wherein the disparity value for each pixel is calculated based on the visibility state change relative to the adjacent pixel.

Preferably, the SDPS matching is configured so that transitions in the visibility state pixel by pixel in the scan line of the Cyclopaean image correspond to preset disparity value changes such that the SDPS algorithm is arranged to calculate the disparity value of each pixel relative to an adjacent pixel based on the visibility state transitions.

Preferably, the SDPS matching algorithm is configured so that visibility state transitions between adjacent pixels in a scan line of the Cyclopaean image are restricted such that direct transitions from ML to MR in the forward direction of the scan line or from MR to ML in the backward direction of the scan line are not permitted.

Preferably, the SDPS matching algorithm is configured such that there is a fixed and known disparity value change for each visibility state transition across the scan line of the Cyclopaean image such that the disparity value changes are limited.

Preferably, the visibility states of the Cyclopaean image pixels are output as occlusion map data in combination with the disparity map data.

Preferably, the logic of the hardware device is arranged to carry out the following steps for each scan line: performing a forward pass of the SDPS algorithm through the image pixel data; storing predecessors generated during the forward pass in a predecessor array; and performing a backward pass of the SDPS algorithm through the predecessor array based on optimal paths to generate disparity values and visibility states for the pixels in the scan line of the Cyclopaean image.

Preferably, the logic of the hardware device comprises control logic for addressing the memory used for storing predecessors in the SDPS algorithm (the predecessor array) and the control logic is arranged so that the predecessor array is addressed left to right for one scan line and right to left for the next scan line so that predecessor array memory cells may be overwritten immediately after they are read by the logic or module which performs the backward pass of the SDPS algorithm.

Preferably, the logic of the hardware device is further configured such that as each new predecessor is stored in a memory address of the predecessor array, the previous predecessor in that memory address is passed to a back track'module that performs the backward pass of the SDPS algorithm.

Preferably, the logic of the hardware device is further configured to perform an adaptive cost function during the forward pass of the SDPS algorithm such that the predecessors are generated by matching mutually adapted pixel intensities, the adaptation being configured to keep differences in the adjacent pixel intensities to within a predefined range.

Preferably, the hardware device may have logic that is reconfigurable or reprogrammable. For example, the hardware device may be a Complex Programmable Logic Device (CPLD) or Field Programmable Gate Array (FPGA). Alternatively, the hardware device may have fixed logic. For example, the hardware device may be an Application Specific Integrated Circuit (ASIC).

In a second aspect, the present invention broadly consists in a computer expansion card for running on a host computer for stereo image matching of a pair of images captured by a pair of cameras, the computer expansion card comprising:
an external device interface for receiving the image pixel data of the pair of images from the cameras;
a hardware device communicating with the external device interface and which is arranged to process and match the image pixel data, the hardware device comprising:
   an input or inputs for receiving the image pixel data from the external device interface,
   logic that is arranged to implement a SDPS matching algorithm, the SDPS matching algorithm being arranged to process the image pixel data to generate disparity map data,
   memory for at least a portion of the algorithm data processing, and
   an output or outputs for the disparity map data; and
a host computer interface that is arranged to enable communication between the hardware device and the host computer, the hardware device being controllable by the host computer and being arranged to transfer the image pixel data and the disparity map data to the host computer.

Preferably, the hardware device further comprises logic that is arranged to implement a distortion removal algorithm and/or an alignment correction algorithm on the image pixel data prior to processing by the SDPS matching algorithm.

Preferably, the hardware device further comprises logic that is arranged to implement a data conversion algorithm that converts the disparity map data generated by the SDPS matching algorithm into depth map data for the output(s).

Preferably, the SDPS matching algorithm is arranged to calculate an optimal depth profile for corresponding pairs of scan lines of the image pixel data. More preferably, the SDPS matching algorithm is arranged to generate disparity map data based on a virtual Cyclopaean image that would be seen by a single camera situated midway between the pair of cameras, such as left and right cameras.

Preferably, the SDPS matching algorithm is arranged to generate disparity map data for each pixel in the Cyclopaean image, scan line by scan line.

Preferably, the pair of cameras comprise a left camera and a right camera, and the SDPS matching algorithm is arranged to select one of three visibility states for each pixel in the Cyclopaean image, the visibility states comprising: ML—monocular left in which the pixel is visible by the left camera only, B—binocular in which the pixel is visible by both cameras, and MR—monocular right in which the pixel is visible by the right camera only.

Preferably, the disparity map data generated by the SDPS matching algorithm comprises a disparity value for each pixel in the Cyclopaean image, and wherein the disparity value for each pixel is calculated based on the visibility state change relative to the adjacent pixel.

Preferably, the SDPS matching is configured so that transitions in the visibility state pixel by pixel in the scan line of the Cyclopaean image correspond to preset disparity value changes such that the SDPS algorithm is arranged to calculate the disparity value of each pixel relative to an adjacent pixel based on the visibility state transitions.

Preferably, the SDPS matching algorithm is configured so that visibility state transitions between adjacent pixels in a scan line of the Cyclopaean image are restricted such that direct transitions from ML to MR in the forward direction of the scan line or from MR to ML in the backward direction of the scan line are not permitted.

Preferably, the visibility states of the Cyclopaean image pixels are output by the hardware device as occlusion map data in combination with the disparity map data.

Preferably, the logic of the hardware device is arranged to carry out the following steps for each scan line: performing a forward pass of the SDPS algorithm through the image pixel data; storing predecessors generated during the forward pass in a predecessor array; and performing a backward pass of the SDPS algorithm through the predecessor array based on optimal paths to generate disparity values for the pixels in the scan line of the Cyclopaean image.

Preferably, the logic of the hardware device comprises control logic for addressing the memory used for storing predecessors in the SDPS algorithm (the predecessor array) and the control logic is arranged so that the predecessor array is addressed left to right for one scan line and right to left for the next scan line so that predecessor array memory cells may be overwritten immediately after they are read by the logic or module which performs the backward pass of the SDPS algorithm.

Preferably, the external device interface is connectable to the cameras for image data transfer and is arranged to receive serial streams of image pixel data from the cameras. In one form, the external device interface may comprise an ASIC that is arranged to receive and convert the serial data streams conforming to the IEEE 1394 protocol (Firewire) into bit parallel data. In another form, the external device interface may comprise Gigabit Ethernet deserializers, one for each camera, that are arranged to receive and convert the serial data streams into bit parallel data.

Alternatively, the external device interface is connectable to the cameras for image data transfer and is arranged to receive bit parallel image pixel data directly from the sensor arrays of the cameras for the hardware device.

Preferably, the computer expansion card is in the form of a Peripheral Component Interconnect (PCI) Express card and the host computer interface is in the form of a PCI Express interface.

Preferably, the hardware device may have logic that is reconfigurable or reprogrammable. For example, the hardware device may be a CPLD or FPGA. Alternatively, the hardware device may have fixed logic. For example, the hardware device may be an ASIC.

Preferably, the expansion card further comprises a configuration device or devices that retain and/or are arranged to receive a configuration file(s) from the host computer, the configuration device(s) being arranged to program the logic of the hardware device in accordance with the configuration file at start-up. Preferably, the configuration device(s) are in the form of reconfigurable memory modules, such as Electrically Erasable Read-Only Memory (EEROM) or the like, from which the hardware device can retrieve the configuration file(s) at start-up.

In a third aspect, the present invention broadly consists in a stereo image matching system for matching a pair of images captured by a pair of cameras comprising:
an input interface for receiving the image pixel data of the pair of images from the cameras;
a hardware device communicating with the input interface and which is arranged to process and match the image pixel data comprising:
   an input or inputs for receiving the image pixel data from the input interface,
   logic that is arranged to implement a SDPS matching algorithm, the SDPS matching algorithm being arranged to process the image pixel data to generate disparity map data,
   memory for at least a portion of the algorithm data processing, and
   an output or outputs for the disparity map data; and
an output interface to enable communication between the hardware device and an external device and through which the disparity map data is transferred to the external device.

Preferably, the hardware device further comprises logic that is arranged to implement a distortion removal algorithm and/or an alignment correction algorithm on the image pixel data prior to processing by the SDPS matching algorithm.

Preferably, the hardware device further comprises logic that is arranged to implement a data conversion algorithm that converts the disparity map data generated by the SDPS matching algorithm into depth map data for the output(s).

Preferably, the SDPS matching algorithm is arranged to calculate an optimal depth profile for corresponding pairs of scan lines of the image pixel data. More preferably, the SDPS matching algorithm is arranged to generate disparity map data based on a virtual Cyclopaean image that would be seen by a single camera situated midway between the pair of cameras, such as left and right cameras.

Preferably, the SDPS matching algorithm is arranged to generate disparity map data for each pixel in the Cyclopaean image, scan line by scan line.

Preferably, the pair of cameras comprise a left camera and a right camera, and the SDPS matching algorithm is arranged to select one of three visibility states for each pixel in the Cyclopaean image, the visibility states comprising: ML—monocular left in which the pixel is visible by the left camera only, B—binocular in which the pixel is visible by both cameras, and MR—monocular right in which the pixel is visible by the right camera only.

Preferably, the disparity map data generated by the SDPS matching algorithm comprises a disparity value for each pixel in the Cyclopaean image, and wherein the disparity value for each pixel is calculated based on visibility state change relative to the adjacent pixel.

Preferably, the SDPS matching is configured so that transitions in the visibility state pixel by pixel in the scan line of the Cyclopaean image correspond to preset disparity value changes such that the SDPS algorithm is arranged to calculate the disparity value of each pixel relative to an adjacent pixel based on the visibility state transitions.

Preferably, the SDPS matching algorithm is configured so that visibility state transitions between adjacent pixels in a scan line of the Cyclopaean image are restricted such that direct transitions from ML to MR in the forward direction of the scan line or from MR to ML in the backward direction of the scan line are not permitted.

Preferably, the SDPS matching algorithm is configured such that there is a fixed and known disparity value change for each visibility state transition across the scan line of the Cyclopaean image such that the disparity value changes are limited.

Preferably, the visibility states of the Cyclopaean image pixels are output by the hardware device as occlusion map data in combination with the disparity map data.

Preferably, the logic of the hardware device is arranged to carry out the following steps for each scan line: performing a forward pass of the SDPS algorithm through the image pixel data; storing predecessors generated during the forward pass in a predecessor array; and performing a backward pass of the SDPS algorithm through the predecessor array based on optimal paths to generate disparity values for the pixels in the scan line of the Cyclopaean image.

Preferably, the logic of the hardware device comprises control logic for addressing the memory used for storing predecessors in the SDPS algorithm (the predecessor array) and the control logic is arranged so that the predecessor array is addressed left to right for one scan line and right to left for the next scan line so that predecessor array memory cells may be overwritten immediately after they are read by the logic or module which performs the backward pass of the SDPS algorithm.

Preferably, the input interface is connectable to the cameras for image data transfer and is arranged to receive serial streams of image pixel data from the cameras. In one form, the input interface may comprise an ASIC that is arranged to receive and convert the serial data streams conforming to the IEEE 1394 protocol (Firewire) into bit parallel data. In another form, the input interface may comprise Gigabit or Camera-link or similar protocol deserializers, one for each camera, that are arranged to receive and convert the serial data streams into bit parallel data.

Alternatively, the input interface is connectable to the cameras for image data transfer and is arranged to receive bit parallel image pixel data directly from the sensor arrays of the cameras for the hardware device.

Preferably, the system is provided on one or more Printed Circuit Boards (PCBs).

Preferably, the hardware device may have logic that is reconfigurable or reprogrammable. For example, the hardware device may be a CPLD or FPGA. Alternatively, the hardware device may have fixed logic. For example, the hardware device may be an ASIC.

Preferably, the stereo image matching system further comprises a configuration device or devices that retain and/or are arranged to receive a configuration file(s) from an external device connected to the output interface, such as a personal computer or other external programming device, the configuration device(s) being arranged to program the logic of the hardware device in accordance with the configuration file at start-up. Preferably, the configuration device(s) are in the form of reconfigurable memory modules, such as Electrically Erasable Read-Only Memory (EEROM) or the like, from which the hardware device can retrieve the configuration file(s) at start-up.

The phrase “hardware device” as used in this specification and claims is intended to cover any form of Programmable Logic Device (PLD), including reconfigurable devices such as Complex Programmable Logic Devices (CPLDs) and Field-Programmable Gate Arrays (FPGAs), customised Application-Specific Integrated Circuits (ASICs), Digital Signal Processors (DSP) and any other type of hardware that can be configured to perform logic functions.

The term “comprising” as used in this specification and claims means “consisting at least in part of”. When interpreting each statement in this specification and claims that includes the term “comprising”, features other than that or those prefaced by the term may also be present. Related terms such as “comprise” and “comprises” are to be interpreted in the same manner.

The invention consists in the foregoing and also envisages constructions of which the following gives examples only.

### BRIEF DESCRIPTION OF THE DRAWINGS

Preferred embodiments of the invention will be described by way of example only and with reference to the drawings, in which:

FIG. 1 shows a block schematic diagram of a preferred form stereo image matching system of the invention in the form of a computer expansion card running on a host computer and receiving image data from external left and right cameras;

FIG. 2 shows a block schematic diagram of the computer expansion card and in particular showing the card modules and interfacing with the host computer;

FIG. 3 shows a flow diagram of the data flow from the cameras through the stereo matching system;

FIG. 4 shows a schematic diagram of the stereo camera configuration, showing how a Cyclopaean image is formed and an example depth profile generated by a Symmetric Dynamic Programming Stereo (SDPS) matching algorithm running in a hardware device of the stereo matching system;

FIG. 5 shows a schematic diagram of the arrangement of the processing modules of the SDPS matching algorithm running in the hardware device of the stereo matching system;

FIG. 6 shows a schematic diagram of the configuration of key logic blocks for the forward pass of the SDPS matching algorithm as implemented in the hardware device of the stereo matching system;

FIG. 7 shows a schematic diagram of an example of predecessor array space minimisation circuitry that may form part of the SDPS matching algorithm; and

FIG. 8 shows a schematic diagram of the configuration of key logic blocks for an alternative form of SDPS matching algorithm that employs an adaptive cost calculation function.

### DETAILED DESCRIPTION OF PREFERRED EMBODIMENTS

The present invention relates to a stereo image matching system for matching a pair of images captured by a pair of cameras to generate disparity map data and/or depth map data. The system is primarily for use in real-time 3D stereo vision applications that require fast and accurate pre-processing of a pair of stereo images for use by higher-level 3D image processing software and applications used in real-time 3D stereo vision applications.

The system is arranged to receive and process a pair of digital images captured by a pair of cameras viewing a scene from different perspectives. For the purpose of describing the system, the pair of images will be called ‘left’ and ‘right’ images captured by ‘left’ and ‘right’ cameras, although it will be appreciated that these labels do not reflect any particular locality and/or orientation relationship between the pair of cameras in 3D space.

At a general level, the system comprises an input interface that connects to the pair of cameras and is arranged to receive the image pixel data for processing by a dedicated hardware device. The hardware device is configured to process the image pixel data to generate disparity map data by performing a Symmetric Dynamic Programming Stereo (SDPS) matching algorithm on the image pixel data. An output interface is provided in the system for transferring the disparity map data generated to an external device. The output interface also enables communication between the external device and the hardware device of the system. For example, the external device may control the operation of the hardware device. Depending on the application, one or more separate hardware devices may be configured to co-operate together to perform the image processing algorithms in other forms of the system. For example, multiple hardware devices may be required when very high resolution images are being processed or when extremely detailed 3D information is required.

In the preferred form, the hardware device of the system is also arranged to implement one or more image correction algorithms on the image pixel data prior to processing of the data by the SDPS matching algorithm. For example, the hardware device may be configured to implement a distortion removal algorithm and/or an alignment correction algorithm on the image pixel data received from the cameras. The corrected left and right image pixel data is then transferred to the SDPS matching algorithm for processing. The hardware device is preferably configured with an output for transferring the corrected left and right image pixel data to the output interface for an external device to receive along with the disparity map data.

In the preferred form, the hardware device of the system may also be arranged to implement a data conversion algorithm that is arranged to convert the disparity map data generated by the SDPS matching algorithm into depth map data. The hardware device preferably comprises an output for transferring the depth map data to the output interface for an external device to receive.

In the preferred form, the system is arranged to receive the left and right image pixel data and process that data with a hardware device to generate output comprising corrected left and right image pixel data, and 3D information in the form of disparity map data and/or depth map data. The data generated by the system can then be used by higher-level 3D image processing software or applications running on an external device, such as a personal computer or the like, for real-time 3D stereo vision applications. For example, the image data and 3D information generated by the system may be used by higher-level image processing software to generate a fused Cyclopaean view of the scene containing 3D information, which can then be used as desired in a real-time application requiring such information.

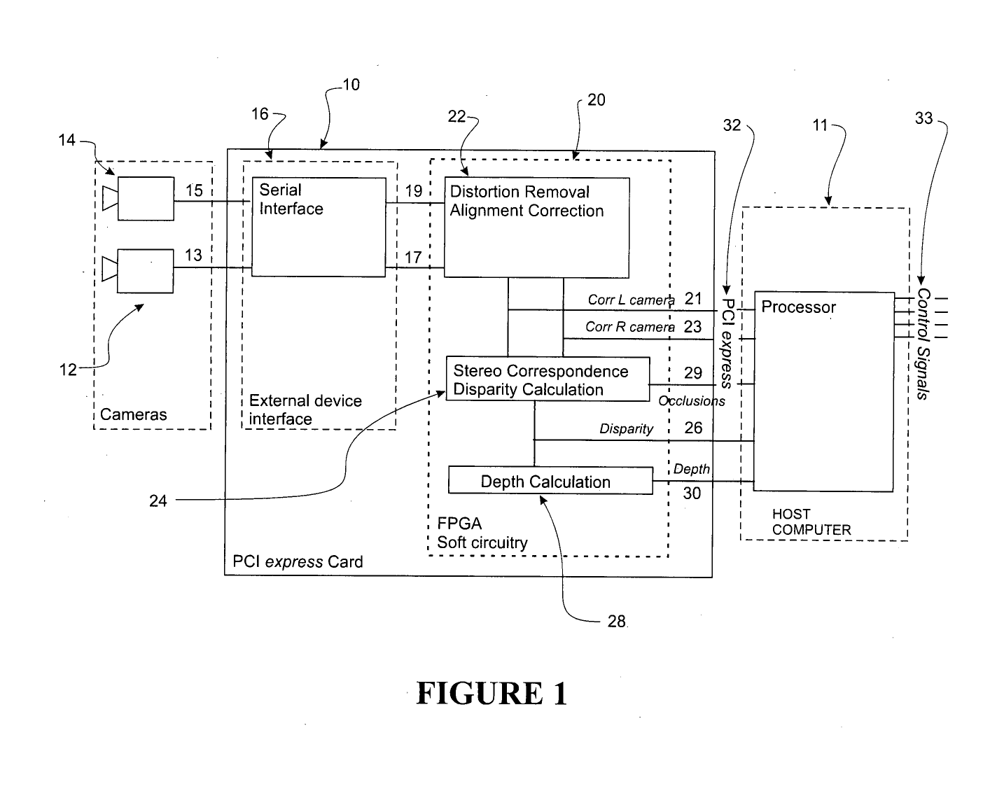

By way of example only, and with reference to FIGS. 1-8, the stereo image matching system will be described in more detail in the form of a computer expansion card. However, it will be appreciated that the system need not necessarily be embodied in a computer expansion card, and this it could be implemented as a ‘stand-alone’ module or device, such as implemented on a Printed Circuit Board (PCB), either connected to an external device by wires or wirelessly, or as a module connected onboard a 3D real-time stereo vision system or application-specific device.

### Computer Expansion Card—Hardware Architecture

Referring to FIG. 1, a preferred form of the stereo image matching system is a computer expansion card 10 implementation for running on a host computer 11, such as a personal computer, or any other machine or computing system having a processor. In the preferred form, the computer expansion card is in the form of a Peripheral Component Interconnect (PCI) Express card, but it will be appreciated that any other type of computer expansion card implementation, including but not limited to expansion slot standards such as Accelerated Graphics Port (AGP), PCI, Industry Standard Architecture (ISA), Micro Channel Architecture (MCA), VESA Local Bus (VLB), CardBus, PC card, Personal Computer Memory Card International Association (PCMCIA), and Compact Flash, could alternatively be used.

In operation, the expansion card 10 is installed and runs on a host computer 11, such as a personal computer, laptop or handheld computer device. In the preferred form, the expansion card is a PCI Express card that is installed and runs on a desktop personal computer. The input interface of the expansion card 10 is in the form of an external device interface 16 that can connect by cable or wirelessly to the pair of left 12 and right 14 digital cameras to receive the left 13 and right 15 image pixel data of a pair of left and right images of a scene captured by the cameras. Typically, the digital cameras 12,14 are of the type that transfer image pixel data from captured images in a serialised form and in the external device interface is arranged to extract pixel data from the serial bit streams from the cameras and pass individual pixels to a hardware device 20 for processing.

In the preferred form, the external device interface 16 comprises a serial interface for converting the serial data streams from the cameras into parallel data streams. By way of example, the serial interface may be a Firewire interface that comprises one or more Application Specific Integrated Circuits (ASIC) that are arranged to receive and convert serial data streams from the cameras conforming to the IEEE 1394 protocol (Firewire) into, for example, left 17 and right 19 bit parallel data. It will be appreciated that other forms of external device interfaces may alternatively be used for transferring the image pixel data from the cameras to the expansion card 10, including Universal Serial Bus (USB) or Ethernet or the like. Alternatively, a Camera Link bit parallel link may be provided to transfer image pixel data from the cameras to the expansion card 10. Further, the expansion card 10 may be provided with two or more different types of external device interfaces 16 for connecting to different types of cameras or to suit different application requirements.

In yet another alternative, depending on the application, the digital cameras 12,14 may allow for direct connection to their sensor arrays to enable direct transfer of image pixel data from sensor arrays to the expansion card. For example, custom cameras may be used that comprise an image sensor and support circuitry (preferably, but not necessarily, a small FPGA) that transmits image data directly to the hardware device 20 of the expansion card 10.

The left 17 and right 19 bit parallel image pixel data is transferred from the external device interface 16 to a hardware device 20 that processes the data with a number of modules to generate corrected left and right image pixel data, and corresponding 3D information in the form of disparity map data and/or depth map data. In the preferred form, the hardware device 20 is in the form of a Programmable Logic Device (PLD) that has reconfigurable or reprogrammable logic. In the preferred form, the hardware device 20 is a Field Programmable Gate Array (FPGA), but alternatively it may be a Complex Programmable Logic Device (CPLD). It will be appreciated that the hardware device 20 may alternatively be an Application Specific Integrated Circuit (ASIC) or Digital Signal Processor (DSP) if desired.

The FPGA 20 preferably comprises input(s) or input circuitry for receiving the image pixel data, logic that is configured to implement processing algorithms, internal memory for the algorithm data processing, and output(s) or output circuitry for the corrected image pixel data and 3D information data.

In the preferred form, the hardware logic in the FPGA 20 is configured to perform three image processing tasks with three respective modules. The first module is an image correction module 22 that is arranged to implement image correction algorithms. In the preferred form, the image correction module 22 performs a distortion removal algorithm and an alignment correction algorithm on the image pixel data 17,19 to generate corrected left 21 and right 23 image pixel data, which is transferred to both the image matching module 24 and output interface 32 of the expansion card 10.

The image correction module 22 is arranged to remove the distortion introduced by the real lenses of the cameras 12,14 from the images and, if necessary, corrects for any misalignment of the pair of cameras. It will be appreciated that various forms of distortion removal and alignment correction algorithms could be used, and there are many such algorithms known to those skilled in the art of image processing. By way of example, a LookUp Table (LUT) or the like may be used. In alternative forms, the image correction module 22 may be moved into another FPGA that is linked directly to the image sensor(s). For example, the cameras may be provided with image correction modules 22 at their output thereby generating corrected image pixel data 21,23 for direct processing by the second module 24 of the main FPGA 20.

In the preferred form, the second module in the main FPGA 20 is an image matching module 24 that is arranged to implement an SDPS matching algorithm for matching the corrected left 21 and right 23 image pixel data and generating dense disparity map data 26 for the left and right images that is output to the output interface 32. In the preferred form, the image matching module 24 is also arranged to output occlusion map data 29 to the output interface 32 in parallel with the disparity map data 26. The SDPS matching algorithm will be explained in more detail later. In the preferred form, the disparity map data 26 is also transferred to the third module, which is a depth calculation module 28.

As mentioned, the third module is a depth calculation module 28. This module 28 is arranged to implement a data conversion algorithm for converting the disparity map data 26 generated by the image matching module 24 into depth map data 30. Conversion algorithms for converting from disparity map data to depth map data are well known and it will be appreciated by those skilled in the art that any such algorithm may be used in the system. By way of example, the data conversion algorithm may convert the disparity data into depth values using direct division or alternatively a LookUp Table (LUT) may be used.

The image correction module 22 and depth calculation module 28 are preferred features of the system, but are not necessarily essential. It will be appreciated that the image matching module 24 could process raw image pixel data 17,19 that has not been corrected for distortion and alignment, but that the resulting disparity map data may not be as accurate. The depth calculation module 28 is also optional, as the disparity map data 26 from the image matching module 24 may be directly transferred to the output interface 32 for use by external devices. In alternative forms, the hardware device 20 may be arranged to output any or all of corrected left 21 and right 23 image data, disparity map data 26, occlusion map data 29, and depth map data 30, depending on design requirements or the requirements of the higher level 3D image processing application of the external device.

In the preferred form, the FPGA 20 is arranged to output the corrected left and right image pixel data 21,23 from the image correction module 22 and the 3D information data. The 3D information data comprises at least the primary disparity map data 26 from the image matching module 24, but optionally may also preferably include the occlusion map data 29 from the image matching module and depth map data 30 from the depth calculation module 28. The output data from the FPGA 20 is transferred to the output interface 32 of the expansion card 10, which in the preferred form is a host computer interface in the form of a PCI Express bus, but could alternatively be any other high speed data transfer link. The PCI Express bus transfers the corrected image pixel data 21,23 and 3D information data to the host computer 11 where it is interpreted by higher-level 3D image processing software or applications. It will be appreciated that higher-level programs on the host computer 11 may generate one or more control signals 33 for controlling external systems such as 3D displays or any other external devices or systems required by the real-time 3D vision application.

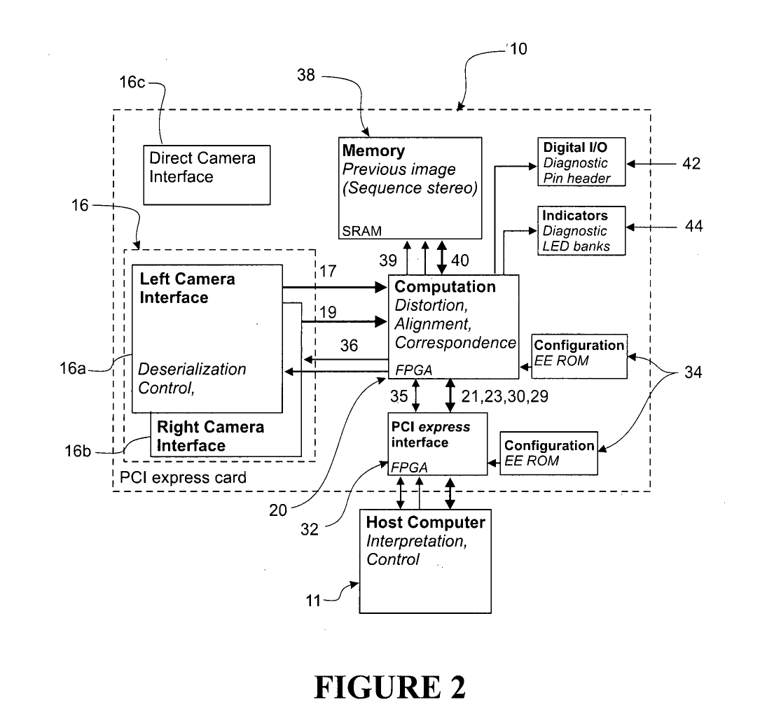

Referring to FIG. 2, the initialisation, configuration and control of the expansion card 10 modules and circuitry will be explained in more detail. As mentioned, the preferred form expansion card 10 comprises an external device interface 16 in the form of a serial interface for connecting to the left and right cameras for retrieving image pixel data. The preferred form external device interface 16 comprises a dedicated camera interface module 16a,16b for interfacing with and controlling each of the left 12 and right 14 cameras, although a single interface module could be used if desired. As mentioned above, the external device interface 16 converts the serialised data streams from the cameras into, for example, bit parallel data 17,19 for processing by FPGA 20. In the preferred form, each camera interface module 16a,16b is in the form of a ASIC, but it will be appreciated that any other form of programmable logic device could alternatively implement the camera interface modules. Each camera interface module 16a,16b can be arranged to implement any form of interface protocol for retrieving and deserialising the image pixel data streams from the cameras for processing. In the preferred form, the camera interface modules implement Firewire protocol interfacing for data transfer from the cameras, but it will be appreciated that any other form of interface protocol such as Ethernet, Camera Link, or other proprietary protocol could alternatively be used for retrieving and converting the image pixel data from the cameras.

In the preferred form, each camera interface module 16a,16b implements a specific type of transfer protocol, such as Firewire, but it will be appreciated that the modules can be configured to implement multiple types of interface protocols, and may be switchable between them. Alternatively, the external device interface 16 may be provided with multiple separate camera interface modules, each dedicated to implementing a different interface protocol. Such forms of external device interface provides the ability for the expansion card to connect to cameras using different interface protocols, and this may be desirable for expansion cards requiring a high degree of camera compatibility or flexibility as to the data transfer method. Additionally, or alternatively, the expansion card 10 may be provided with a direct camera interface 16c that is arranged for direct connection to the image sensor arrays of the cameras via a parallel cable for direct bit parallel image pixel data extraction for the FPGA 20.

As mentioned, main FPGA 20 is configured to receive the image pixel data, remove distortion from the images, correct the images for camera misalignment, and compute 3D information data for outputting to the host computer interface 32. As mentioned, the host computer bus 32 is a PCI Express bus. In the preferred form, the PCI Express bus interface is implemented by a dedicated programmable hardware device, such as an FPGA or the like. The output interface FPGA 32 is arranged to control the PCI Express bus to transfer the corrected image pixel data and 3D information data generated by main FPGA 20 to the host computer 11, and it also may transfer control signals 35 from the host computer to the main FPGA 20 for controlling its operation and data transfer.

The FPGAs 20,32 are both connected to associated configuration devices 34 that each retain configuration files for the programming the FPGAs at power-up/start-up. In the preferred form, the configuration devices 34 are in the form of memory modules, such as Electrically Erasable Read-Only Memory (EEROM), but it will be appreciated that other types of suitable memory modules could alternatively be used, including by way of example Read-Only Memory (ROM), Flash memory, Programmable ROM (PROM) and the like. When power is applied, the expansion card 10 configures itself by loading programs into the FPGAs 20,32 from the respective EEROMs 34. In particular, the configuration files stored in the EEROMs 34 are arranged to program the logic of the FPGAs 20,32 to perform the desired processing. In the preferred form, the configuration files enable the entire circuit of the FPGAs 20,32 to be changed. The image resolution, distortion and alignment correction tables, depth resolution and whether disparity or depth data is transmitted to the host can be altered. It will be appreciated that an independent program can be used to generate the configuration files. Further, it will be appreciated that the configuration files or FPGA program data may be loaded into the FPGAs 20,32 directly from the host computer 11 or another external programming device if desired.

After start-up, an initialisation routine runs on the main FPGA 20 to configure the remainder of the system. These configurations include, for example, setting the cameras to fire simultaneously and to stream interleaved image pixel data into the external device interface 16 via connection cables or links. In this respect, the main FPGA 20 generates control signals 36 for controlling the external device interface 16 and the cameras via the external device interface. These control signals may be generated internally by the algorithms running on the main FPGA 20, or may be transferred by the main FPGA 20 in response to instruction/control signals 35 received from the host computer 11.

In the preferred form, the main FPGA 20 is connected to a memory module 38 on the expansion card for storing data in relation to previous images captured by the cameras. In the preferred form, the memory module 38 is in the form of Random Access Memory (RAM), such as Static RAM (SRAM), but other memory could alternatively be used if desired. Control signals 39 and image pixel data 40 flow between the main FPGA 20 and SRAM 38 during operation for storage of previous images for the purpose of improving the quality of stereo matching. The memory module 38 may also be used for storage of the pixel shift register(s) 56 and/or the predecessor array 48 in order to allow a larger number of disparity calculator circuits 72 to be implemented in the internal memory of the main FPGA 20. These aspects of the hardware architecture will be explained in more detail below. The memory module 38 may also consist of one or more independent sub-modules configured for various purposes.

The preferred form expansion card 10 is also provided with a Digital I/O pin header 42 connected to the main FPGA 20 for diagnostic access. An expansion card diagnostic indicator module 44, for example in the form of LED banks, is also connected to specific main FPGA 20 outputs for operation and diagnostic indications.

### Computer Expansion Card—Data Flow

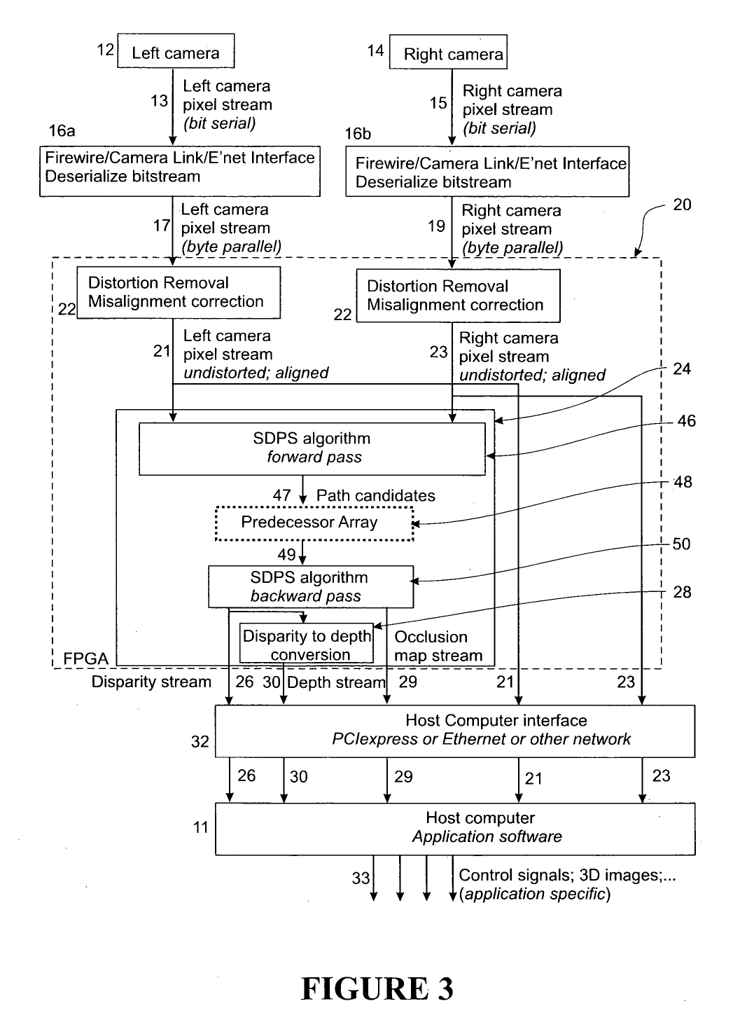

Referring to FIG. 3, the flow of data through the preferred form expansion card 10 will be described by way of example only. The left and right images captured by the pair of left 12 and right 14 digital cameras are sent from the cameras as streams of left 13 and right 15 image pixel data, for example pixel streams in bit serial form. The camera interface modules 16a,16b of the external device interface 16 receive the serialised pixel streams 13,15 from the cameras 12,14 and convert the data into bit parallel form 17,19 for processing by the main FPGA 20. The left 17 and right 19 image pixel data is processed in the main FPGA 20 by the image correction module 22 to correct for cameras lens distortions and for alignment. The corrected left 21 and right 23 image pixel data is then passed through the image matching module 24 for processing by the SDPS algorithm, as well as being directly channeled to the host computer interface 32.

In the preferred form, the corrected image pixel data 21,23 is processed in three steps by the image matching module 24. First, the data 21,23 is subjected to a forward pass 46 of the SDPS algorithm to generate path candidates 47. Second, the path candidates 47 are stored by a predecessor array 48. Third, the data stored 49 in the predecessor array 48 is then subjected to a backward pass 50 of the SDPS algorithm to generate a data stream of disparities (disparity map data 26) and visibility states (occlusion map data 29). The occlusion map data 29 can be used to outline objects in a scene that are clearly separated from their backgrounds.

In the preferred form, the disparity map data stream 26 is then passed through the depth calculation module 28 that is arranged to convert the disparity map data stream into a depth value data stream 30. The depth value data stream is output by the main FPGA 20 to the host computer interface 32. As previously mentioned, the host computer interface 32 preferably transfers the disparity map data stream 26, occlusion map data stream 29, depth value data stream 30, and corrected image pixel data 21,23 to the host computer 11 for processing by higher-level 3D application software. The 3D application software running on the host computer may then be arranged to generate and output 3D images from the host computer or to cause the host computer to generate control signals and/or 3D data 33 about the scene captured by the cameras 12,14 for controlling external systems for specific real-time applications.

### SDPS Algorithm—Hardware Configuration and Main Logic Blocks

The image matching module 24 implemented in the main FPGA 20, and in particular the SDPS algorithm, will now be explained in more detail. As mentioned, the image matching module 24 is configured to process the corrected image pixel data 21,23 and convert it into disparity map data 26 and in addition optionally output occlusion map data 29.

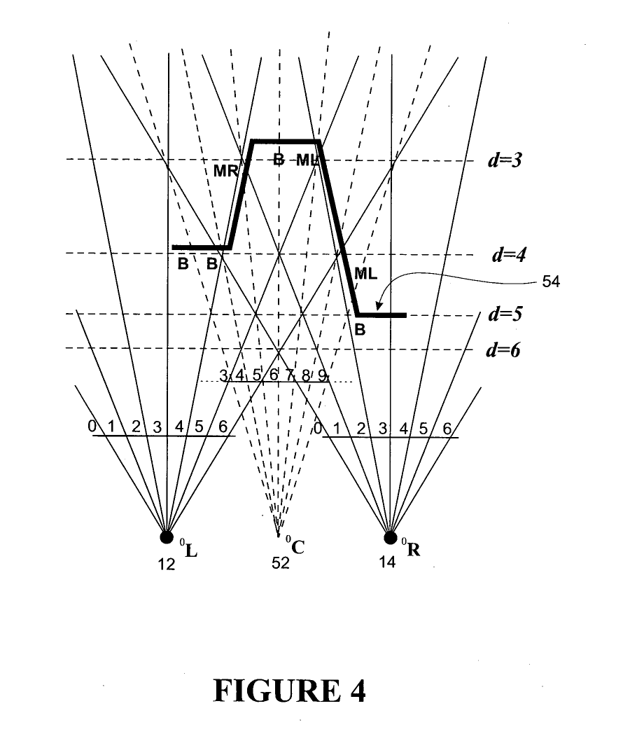

Referring to FIG. 4, a schematic diagram of a preferred stereo camera configuration is shown. The schematic diagram shows how a Cyclopaean image (one seen by a single Cyclopaean eye 52) is formed and an example depth profile 54 generated by the Symmetric Dynamic Programming Stereo (SDPS) matching algorithm. The notations ML (monocularly visible left—seen only by the left camera 12), B (binocularly visible—seen by both cameras 12,14) and MR (monocularly visible right—seen only by the right camera 14) describe the visibility states of the disparity profile processed by the SDPS algorithm.

The SDPS algorithm generates a ‘symmetric’ solution to image pixel matching—one in which the left and right images have equal weight. The SDPS algorithm is based on a virtual Cyclopaean camera 52 with its optical centre on the baseline joining the optical centers of the two real cameras 12,14. FIG. 4 shows the canonical arrangement. Pixels of the Cyclopaean image support a ‘vertical stack’ of disparity points in the object space with the same location in the Cyclopaean image plane. These points fall into the three classes above, namely ML, B, and MR. As will be described, only certain transitions between classes are allowed due to visibility constraints when moving along a scan line. Further the SDPS algorithm is based on the assumption of a canonical stereo configuration (parallel optical axes and image planes with collinear scan lines) such that matching pixels are always found in the same scan line.

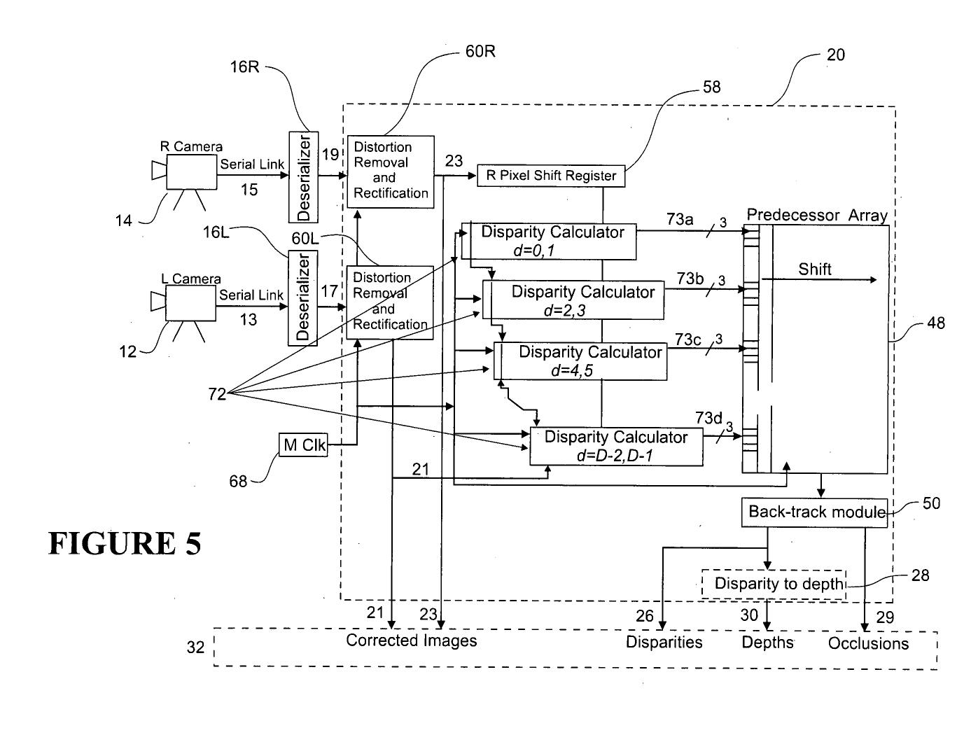

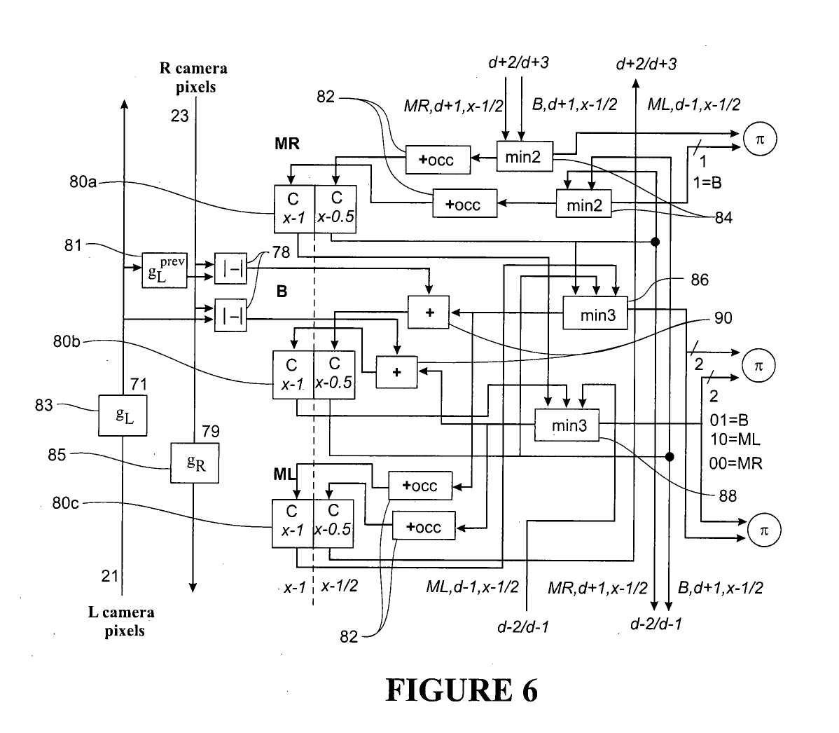

Referring to FIG. 5, a schematic diagram of one possible form of logic arrangement for the modules configured in the main FPGA 20 is shown. The left 17 and right 19 bit parallel image pixel data streams are fed into respective distortion removal and rectification modules 60R and 60L of the image correction module 22. The distortion removal and rectification modules 60R,60L are arranged to generate corrected pixels 21,23 in relation to any distortion and misalignment. The left corrected pixels 21 are fed into the disparity calculator 72 for the largest pair of disparities. The right corrected pixels 23 are fed into a right corrected pixel shift register 58 having one entry for each possible disparity. The pixel streams 21,23 travel in opposite directions through the disparity calculators 72. Registers 81,83,85 in the disparity calculators 72 form a distributed shift register as shown in FIG. 6 to be described later. Clock module 68 generates the master clock. In the preferred form, the master clock is divided by two to produce the pixel clock which controls the image correction module 22. The disparity calculators 72 operate in ‘even’ and ‘odd’ phases. The ‘even’ phase is used to calculate even disparity values and integer pixel coordinates in the Cyclopaean image. The ‘odd’ phase is used to calculate odd disparity values and half integer pixel coordinates in the Cyclopaean image.

The image matching module 24 is controlled by the master clock and comprises one or more disparity calculators 72 that receive the right corrected pixels 23 and left corrected pixels 23 for generating visibility state values 73a-73d during a forward pass of the SDPS algorithm. There is one disparity calculator 72 for each pair of possible disparity values, the number of which may be selected based on design requirements.

The disparity calculators 72 send the calculated visibility state values 73a-73d for storage in a predecessor array 48. The back-track module 50 reads the predecessor array 48 by performing a backward pass of the SDPS algorithm through the values stored in the predecessor array and generates an output stream of disparity values 26 corresponding to the corrected image pixel data 21,23. Optionally, the disparity value data stream 26 may then be converted to a depth value data stream 30 by the depth calculation module 28. In the preferred form, the back-track module 50 also generates an output stream of occlusion data 29, which represents the visibility states of points or pixels in the Cyclopaean image. By way of example, up to five streams of data are fed via a fast bus (for example, PCI express) of the host computer interface 32 to a host computer for further processing: left 21 and right 23 corrected images, disparities 26, depths 30 and occlusions or visibility states 29. The particular data streams can be configured depending on the host computer application requirements, but it will be appreciated that the primary 3D information data is the disparity map data 26, and the other data streams are optional but preferable outputs.

Referring to FIG. 6, a schematic diagram of the preferred configuration of the main logic blocks of a disparity calculator 72 for the forward pass of the SDPS algorithm as implemented in the main FPGA 20 is shown. The configuration and layout of the logic blocks is described below, followed by a more general description of the SDPS matching algorithm process.

The absolute value of the difference between the incoming left pixel intensity 71 (or the previous left pixel stored in the register 81) and the intensity of right image pixel 79 is calculated by the absolute value calculators 78. The FIG. 6 schematic shows the two circuits which calculate the even and odd disparities for the disparity calculator. Three two element cost registers 80a-80c are provided. Cost register 80a is a 2-element register for MR state costs for odd and even disparities. Cost register 80b is a 2-element register for B state costs. Cost register 80c is a 2-element register for ML state costs. Occlusion modules 82 are arranged to add an occlusion penalty in relation to cost registers 80a and 80c. Selection modules 84 are arranged to select the minimum of two inputs in relation to cost register 80a. Selection modules 86 and 88 are arranged to select the minimum of three inputs in relation to cost registers 80b and 80c. Adder modules 90 are fed by the outputs of the absolute value calculators 78 and selection modules 86,88, and sends the sum of these outputs to cost register 80b. Together circuit elements 78, 80a, 80b, 80c, 82, 84, 86, and 90 compute cost values in accordance with the equations for accumulated costs C(x,y,p,s) as explained below.

To save space, it will be appreciated that in alternative forms this circuit could be implemented with only one instance of the duplicated elements 78, 82, 84, 86, 88 and 90 and additional multiplexors to select the appropriate inputs for the even and odd phases which calculate even and odd disparities, respectively.

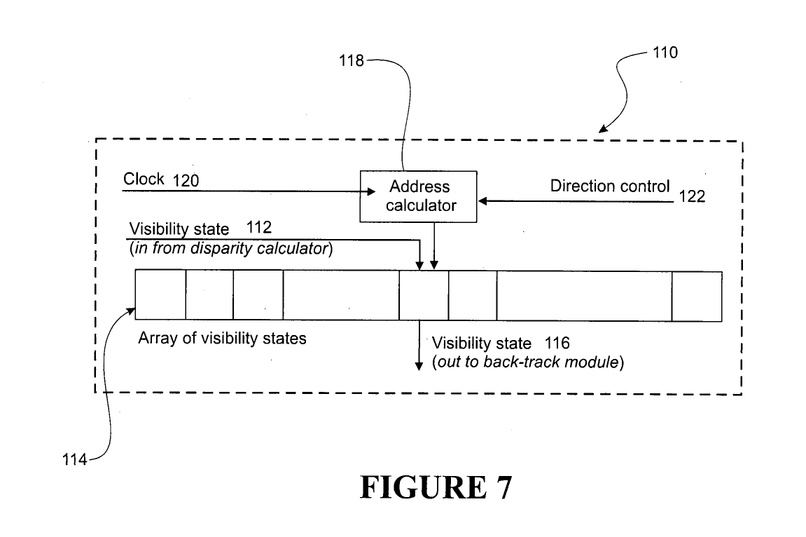

With reference to FIG. 7, a predecessor array space minimisation circuit or module(s) 110 may optionally be implemented to minimize the space required for the predecessor array 48 that stores visibility states generated by the disparity calculators 72. The space minimisation module 110 is arranged so that as each new visibility state value 112 is added by the disparity calculator 72 into the array 114 of visibility states in the predecessor array 48, the visibility state value 116 for the previous line (array) is ‘pushed out’ and used by the back track module 50. The space minimisation module 110 comprises an address calculator 118 that generates the memory address for the predecessor array 48 for the incoming visibility state value 112. In the preferred form, the address calculator 118 is arranged to increment the memory addresses for one line, and decrement them for the next line. The address calculator 118 generates a new memory address each clock cycle 120 and a direction control signal 122 coordinates the alternating increment and decrement of the addresses. In an alternative form of the space minimisation module 110, a bi-directional shift register, which pushes the last value of the previous scan line out when a new value is shifted in, could be used.

### SDPS Algorithm—General Process

The Symmetric Dynamic Programming Stereo (SDPS) matching algorithm uses a dynamic programming approach to calculate an optimal ‘path’ or depth profile for corresponding pairs of scan lines of an image pair. It considers the virtual Cyclopaean image that would be seen by a single camera situated midway between the left and right cameras as shown in FIG. 4 and reconstructs a depth profile for this Cyclopaean view.

A key feature of this ‘symmetric’ profile is that changes in disparity along it are constrained to a small set: the change can be −1, 0 or 1 only. The visibility ‘states’ of points in the profile are labelled ML (Monocular Left—visible by the left camera only), B (Binocular—visible by both cameras) and MR (Monocular Right—visible by the right camera only). Transitions which violate visibility constraints namely ML to MR in the forward direction and MR to ML in the backward direction are not permitted.

Furthermore, to change the disparity level the Cyclopaean image profile moves through one of the ML or MR states. There is a fixed and known change in disparity associated with each state transition. This approach has a very significant advantage, namely that because the changes in depth state are limited and can be encoded in a small number of bits (only one bit for the MR state and two bits for the ML and B states), very significant savings can be made in the space required for the predecessor array 48 in FIG. 5. Since this is a large block of memory, particularly in high resolution images, the total savings in resources and space on the surface of an FPGA or any other hardware device, such as an ASIC, are significant. The hardware circuitry to manipulate the predecessor array 48 is correspondingly smaller since there are fewer bits and the possible transitions are constrained. In contrast, an implementation of a conventional dynamic programming algorithm, like most stereo algorithms, attempts to reconstruct either the left or the right view. This means that arbitrarily large disparity changes must be accommodated and more space used in the predecessor array and larger, slower circuitry to process it in the second (backtrack) phase of the dynamic programming algorithm.

The SDPS matching algorithm processes each scan line in turn, so that the y index in the pixel array is always constant. This allows efficient processing of images streamed from cameras pixel by pixel along scan lines.

Formally, the SDPS matching algorithm may be described as follows:

Let g_{L}(x_{L},y_{L}) represent the intensity of a pixel at coordinate (x_{L},y_{L}) in the left (L) and g_{R}(x_{R},y_{R}) represent the intensity of a pixel at (x_{R},y_{R}) in the right (R) image. Let p=x_{L}−x_{R} represent the x-disparity between corresponding pixels in each image. In Cyclopaean coordinates based on an origin (O_{c} in FIG. 4) midway between the two camera optical centres (O_{L} and O_{R} in FIG. 4), x=(x_{L}−x_{R})/2. The objective of the SDPS matching algorithm is to construct a profile for each scan line (constant y coordinate) p(x,s) where x is the Cyclopaean x coordinate and s the visibility state of the point. s can be ML, B or MR.

In a traditional dynamic programming approach, the cost of a profile is built up as each new pixel is acquired from the cameras via the image correction module 22. The costs, c(x,y,p,s), associated with pixel x in each state of a scan line are:

c(x,y,p,ML)=fixed occlusion cost

c(x,y,p,B)=Cost(x+p/2,y),(x−p/2,y))

c(x,y,p,MR)=fixed occlusion cost

Cost((x,y),(x′,y)) can take many forms, for example, it can be the absolute difference of two intensities:

Cost((x+p/2,y),(x−p/2,y))=|g_{L}(x+p/2,y)−g_{R}(x−p/2,y)|

Many other variations of the Cost( ) function can be used. For example, the squared difference (g_{L}(x,y)−g_{R}(x−d,y))² may be substituted for the absolute difference in the equation above. Generally, any function which penalizes a mismatch, that is differing intensity values, could be used, including functions which take account of pixels in neighbouring scan lines. The fixed occlusion cost separates admissible mismatches from large values of Cost( ) which are atypical of matching pixels. The occlusion cost is an adjustable parameter.

Accumulated costs, C(x,y,p,s), are:

C(x,y,p,ML)=c(x,y,p,ML)+min(C(x−½,y,p−1,ML),C(x−1,y,p,B),C(x−1,y,p,MR))

C(x,y,p,B)=c(x,y,p,B)+min(C(x−½,p−1,ML),C(x−½y,p,B),C(x−1,y,p,MR))

C(x,y,p,MR)=c(x,y,p,MR)+min(C(x−½,y,p+1,B),C(x−½,y,p+1,MR))

The predecessors π(x,y,p,s) are:

π(x,y,p,ML)=arg min(C(x−½,y,p−1,ML),C(x−1,y,p,B),C(x−1,y,p,MR))

π(x,y,p,B)=arg min(C(x−½,y,p−1,ML),C(x−1,y,p,B),C(x−1,y,p,MR))

π(x,y,p,MR)=arg min(C(x−½,y,p+1,B),C(x−½,y,p+1,MR))

Note that, in contrast to many dynamic programming algorithms, in this case, C(x,y,p,s) depends only on C(x−1,y,p,s) and C(x−½,y,p′,s), where p′=p−1 or p+1. This means that the whole cost array does not need to be stored. Two-entry registers 80a-80c are used for each s value and they store previous cost values. In FIG. 6, in each computation cycle, the values read from these registers are C(x−1, . . . , . . . , . . . ) and C(x−½, . . . , . . . , . . . ). On the rising edge of the next clock, the current C(x−½, . . . , . . . , . . . ) replaces C(x−1, . . . , . . . , . . . ) becoming C(x−1, . . . , . . . , . . . ) for the next cycle and a new value for is placed to the C(x−½, . . . , . . . , . . . ) location. FIG. 6 shows the circuitry used to evaluate the C values. As each C value is generated, the best predecessor π(x,y,p,s) is stored in the predecessor array 48 in FIG. 5 in this forward pass of the SDPS algorithm.

In the second phase, the lowest cost value is chosen from the final values generated for all disparity values. If the image is w pixels wide, the disparity profile consists of up to w tuples {p,s} where p is a disparity value and s a visibility state.

The backtracking process or backward pass of the SDPS matching algorithm starts by determining the minimum accumulated cost for the final column of the image and using the index of that cost {p,s} to select π(w−1,p,s) from the predecessor array.

The disparity profile is built up in reverse order from d(w−1) back to d(0) by tracking back through the predecessor array 48. Once π(w−1,y,p,s) has been chosen, {p,s} is emitted as d(w−1) and the p and s values stored in π(w−1,y,p,s) are used to select π(x′,y,p,s) for the profile value x′ that immediately precedes the value at w−1. Table 1 shows how this process works to track the optimal best cost ‘path’ through the array. The current index into the predecessor array 48 is {x,p,s}. The preceding state, sₚᵣ, is stored at location n(x,y,p,s). pₚᵣ and xₚᵣ are derived following the rules in Table 1. π(xₚᵣ,y,pₚᵣ,sₚᵣ) is then read from the predecessor array 48. Note that when xₚᵣ is x−1, this effectively skips a column (x−½) in the predecessor array. This process is repeated until d(0) has been chosen. Note that the preferred way to output the disparity map is in reverse order: from d(w−1) down to d(0). This effectively saves a whole scan line of latency as the interpretation modules residing on the host computer can start processing d values as soon as d(w−1) is chosen. In general, the system does not have to wait until the trace back to d(0) is completed. In some applications, it may be preferable to output the disparity profile in the same order as camera pixels are output: a pair of last-in-first-out (LIFO) or stack memory structures may be used for this purpose. As mentioned above, the disparity profile for the Cyclopaean image consists of the disparity values (disparity map data 26) and visibility state values (occlusion map data 29) selected during the back tracking process.

The control logic for the predecessor array 48 may address it from left to right for one image scan line and from right to left for the next so that predecessor array memory cells currently indexed as π(x,y,p,s) may be overwritten by values for π(x−2w,y+1,p,s) immediately they have been read by the backward pass of the SDPS algorithm.

Finally, if required by higher-level 3D application programs in the host computer, disparities are converted to depth values, preferably by accessing a look-up table. However, it will be appreciated that other conversion techniques may be used, for example directly calculating the disparity to depth conversion using dividers, multipliers and other conventional circuit blocks. It will also be appreciated that, if bandwidth from the FPGA 20 to an external device is limited, it would suffice to transfer the starting disparity map point for each line and the occlusion map data. The external device can then reconstruct the disparity map data for each line.

TABLE 1
Transitions in the disparity profile

| | | | Preceding | | |
|---|---|---|---|---|---|
| Current profile node | | | profile node | Output d(next) | |
| d(x) | Disparity p | State s | State sₚᵣ | x coordinate | Disparity, p |
| x | p | B | B | x − 1 | p |
| | | | ML | x − ½ | p − 1 |
| | | | MR | x − 1 | p |
| | | ML | B | x − 1 | p |
| | | | ML | x − ½ | p − 1 |
| | | | MR | x − 1 | p |
| | | MR | B | x − ½ | p + 1 |
| | | | MR | x − ½ | p + 1 |

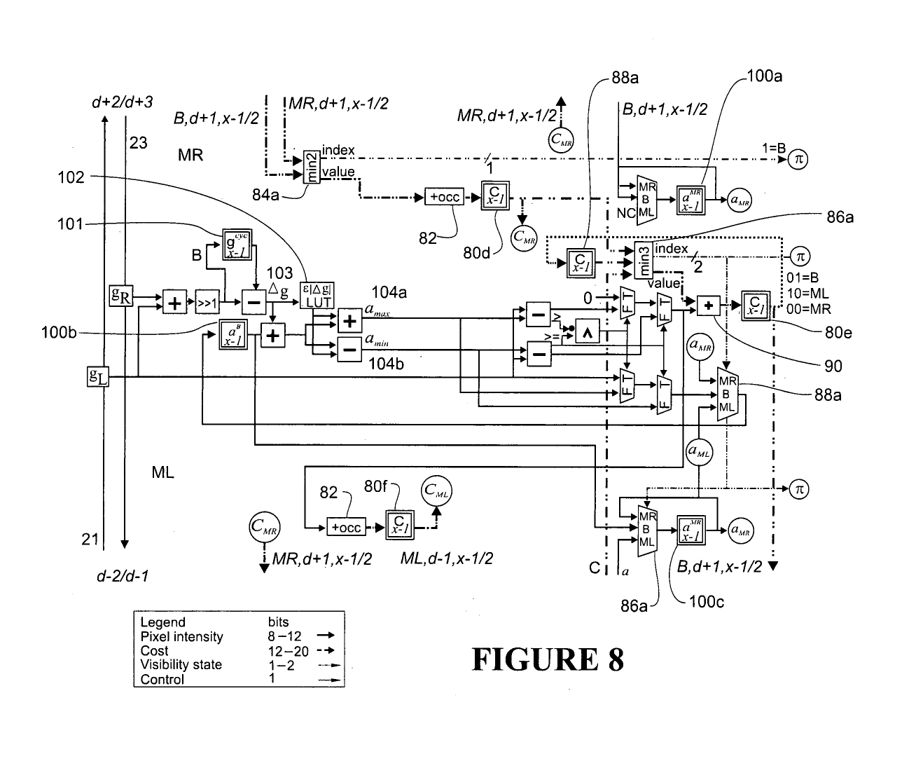

Adaptive Cost Calculation Optimisation With reference to FIG. 8, an alternative form of the SDPS matching algorithm circuit is shown. The basic circuit is similar to that described in FIG. 6, but employs adaptive cost function circuitry in order to tolerate contrast and offset intensity. The adaptive cost function circuitry can provide increased tolerance of intensity contrast and offset variations in the two left and right views of the scene. The cost registers, 80d, 80e and 80f store the costs. Circuits 84a and 86a choose the minimum cost from allowable predecessors. An adapted intensity is stored in the registers, 100a, 100b and 100c, and which is calculated based on an adaptive cost function. The cyclopean intensity is calculated and stored in register 101. The memory, 102, is addressed by the signal Δg. Limits on the range of intensities which are considered ‘perfect’ matches, aₘₐₓ, 104a, and aₘₑₙ, 104b, are calculated and compared with the left pixel intensity, g_{L}, 105, and used to generate a similarity value, 106, which is added to the best previous cost and stored in the cost register, 80d. Together circuit elements 78 80d, 80e, 80f, 82, 84, 86, 90, 100a, 100b, 100c, 101, 102 and 90 compute values 103 104a and 104b and cost values in accordance with the equations for accumulated costs C(x,y,p,s) explained below for the adaptive variant explained below.

As mentioned above the adaptive cost function may be used to further improve the matching performance of the SDPS algorithm in some forms of the system. The adaptive cost function can take many forms, but the general form defines adaptively an admissible margin of error and reduces the cost when mutually adapted corresponding intensities differ by less than the margin. One possible form of the adaptive cost function circuitry is shown in FIG. 8 as described above, and the function is explained further below by way of example only.

The circuitry of FIG. 8 computes the Cyclopaean image intensity for the current position as g(x)^{cyc}=½(g_{L}(x)+g_{R}(x)) and the difference between gₓ^{cyc} and a stored Cyclopaean intensity, g(xₚᵣ)^{cyc}: Δg=g(x)^{cyc}−g(x−1)^{cyc} for the predecessor (x−1,y,p,B), For the predecessors (x−1,y,p,MR) and (x−½,y,p,ML), the stored Cyclopaean intensity corresponds to the closest position in the state B along the backward traces from these predecessors. The circuitry then applies an error factor, ε, in the range (0,1), eg ε=0.25, to the absolute value of the difference, |Δg|, to define a range of allowable change, Δg±ε|Δg|, to the previously stored adapted intensity, a(x−1,y,p,B). The cost of a match is then defined in terms of this range. For example, a signal lying within the range is assumed to be a ‘perfect’ match (within expected error) and given a cost of 0. It will be appreciated that the error factor can be selected or adjusted to provide the desired level of accuracy and speed for the image processing.

In general, the cost of a match is: c(x.y,p,B)=f^{sim}(g_{L}, g_{R}, aₓ₋₁), where f^{sim} is a general similarity measure based on the intensity of the left and right pixels, g_{L} and g_{R} respectively, and the stored adapted intensity, aₓ₋₁. One possible similarity function assigns a 0 cost if the left (or right) image pixel intensity lies in the range between aₘᵢₙ=a(x−1,y,p,B)+Δg−ε|Δg| and aₘₐₓ=a(x−1,y,p,B)+Δg+ε|Δg|, ie if aₘᵢₙ<g_{L}<aₘₐₓ

An example complete function is:
if aₘᵢₙ<g_{L}<aₘₐₓ then c(x.y,p,B)=0
else if g_{L}>=aₘₐₓ then c(x.y,p,B)=g_{L}−aₘₐₓ
else c(x.y,p,B)=aₘᵢₙ−g_{L}

However, it will be appreciated that many variations of this, for example using squared differences, may be used.

A new adapted intensity is stored for the next pixel:
if aₘᵢₙ<g_{L}<aₘₐₓ then a(x.y,p,B)=g_{L}
else if g_{L}>=aₘₐₓ then a(x.y,p,B)=aₘₐₓ
else a(x.y,p,S)=aₘᵢₙ

As shown in FIG. 8, an adapted intensity is stored for each visibility state, B, ML and MR. For ML and MR, the stored adapted intensity is that for the closest B state along the optimal path backward from (x,p,ML) or (x,p,MR). The new adapted intensity, a(x.y,p,S), is chosen from three values computed for transitions from the previous profile nodes, (x−1,p,B), (x−0.5,p−1,ML) and (x−1,p,MR). The output from the selection circuits 84a, 86a, and 88a for each visibility state chooses the best previous cost and adapted intensity in the same way that the previous cost is chosen in the FIG. 6 circuitry with reference to the equations for C(x,y,p,S), where S is B, ML or MR except that the cost c(x,y,p,B) is computed separately for each of the three predecessors (B, ML, MR) to account for the stored adapted intensities and Cyclopaean intensities and thus depends on the visibility state of predecessor: c(x,y,p,B|S) so that

$$C ( x , y , p , B ) = min ( \begin{matrix}c ( x , y , p , B \vert ML ) + C ( x - 1 / 2 , y , p - 1 , ML ) , \\ c ( x , y , p , B \vert B ) + C ( x - 1 , y , p , B ) , \\ c ( x , y , p , B \vert MR ) + C ( x - 1 , y , p , MR )\end{matrix} )$$

The multiplication to compute ε|Δg| may be avoided by using a small look up table 102 as shown in FIG. 8. Alternatively, ε may be chosen to be ε=2^{-j}+2^{-k}+ . . . , where only a small number of terms are used in the expansion and ε|Δg| may be computed with a small number of shifts and adds. For example, only two terms could be used: ε=1>>j+1>>k, where >>j represents a shift down by j binary digits. In particular, ε can be chosen to be 0.25, leading to aₘₐₓ=a(x−1,y,p,B)+Δg+|Δg|>>2 and only three small additions or subtractions and a complement operation are required to calculate aₘᵢₙ and aₘₐₓ.

### Real-Time Applications

The stereo image matching system of the invention may be utilised in various real-time 3D imaging applications. By way of example, the stereo image data and 3D information data generated by the stereo image matching system may be used in applications including, but not limited to:
Navigation through unknown environments for moving vehicles or robots—such as collision avoidance for vehicles in traffic, navigation for autonomous vehicles, mobile robot navigation and the like,
Biometrics—such as rapid acquisition of 3D face models for face recognition,
Sports—Sports science and commentary applications,
Industrial control—such as precise monitoring of 3D shapes, remote sensing, and machine vision generally,
Stereophotogrammetry, and
any other applications that require 3D information about a scene captured by a pair of stereo cameras.

The stereo image matching system is implemented in hardware and runs a SDPS matching algorithm to extract 3D information from stereo images. The use of the SDPS matching algorithm in hardware enables accurate 3D information to be generated in real-time for processing by higher-level 3D software programs and applications. For example, accuracy and speed is required in the processing of stereo images in a collision avoidance system for vehicles. Also, accurate and real-time 3D image data is required for face recognition software as more precise facial measurements increases the probability that a face is matched correctly to those in a database, and to reduce ‘false’ matches.

It will be appreciated that the stereo image matching system may process images captured by digital cameras or digital video cameras at real-time rates, for example more than 30 fps. The images may be high resolution, for example over 2 MegaPixels per image. One skilled in the art would understand that much higher frame rates can be achieved by reducing image size or that much higher resolution images can be processed at lower frame rates. Furthermore improved technology for fabrication of the FPGA 20 may enable higher frame rates and higher resolution images.

As mentioned, the stereo image matching system may be implemented in various forms. One possible form is a computer expansion card for running on a host computer, but it will be appreciated that the various main modules of the system main be implemented in ‘stand-alone’ devices or as modules in other 3D vision systems. One possible other form is a stand-alone device that is connected between the cameras and another external application device, such as a personal computer and the like. In this form, the stand-alone device processes the camera images from the cameras and outputs the image and 3D information data to the external device via a high-speed data link. In other forms the cameras may be onboard the stand-alone module. It will also be appreciated that the hardware device, for example the main FPGA 20, that implements the SDPS matching algorithm may be retro-fitted or incorporated directly into other 3D vision systems for processing of stereo images if desired.

The foregoing description of the invention includes preferred forms thereof. Modifications may be made thereto without departing from the scope of the invention as defined by the accompanying claims.

1-64. (canceled)

65. A hardware device for stereo image matching of a pair of images captured by a pair of cameras comprising:
an input or inputs for receiving the image pixel data of the pair of images;
logic that is arranged to implement a Symmetric Dynamic Programming Stereo (SDPS) matching algorithm, the SDPS matching algorithm being arranged to calculate an optimal depth profile for corresponding pairs of scan lines of the image pixel data and process the image pixel data to generate disparity map data;
memory for at least a portion of the algorithm data processing; and
an output or outputs for the disparity map data.

66. A hardware device according to claim 65 further comprising logic that is arranged to implement a distortion removal algorithm and an alignment correction algorithm on the image pixel data prior to processing by the SDPS matching algorithm.

67. A hardware device according to claim 65 wherein the SDPS matching algorithm is arranged to generate disparity map data based on a virtual Cyclopaean image that would be seen by a single camera situated midway between a left camera and a right camera, and the SDPS matching algorithm being arranged to select one of a predefined set of visibility states for each pixel in the Cyclopaean image.

68. A hardware device according to claim 65 wherein the SDPS matching algorithm is arranged to generate disparity map data for each pixel in the Cyclopaean image, scan line by scan line for each corresponding left and right scan lines of the image pixel data.

69. A hardware device according to claim 67 wherein the disparity map data generated by the SDPS matching algorithm comprises a disparity value for each pixel in the Cyclopaean image, and wherein the disparity value for each pixel is calculated based on the visibility state change relative to the adjacent pixel.

70. A hardware device according to claim 69 wherein the SDPS matching algorithm is configured so that transitions in the visibility state between adjacent pixels in each scan line of the Cyclopaean image correspond to preset disparity value changes such that the SDPS algorithm is arranged to calculate the disparity value for each pixel based on the disparity value of an adjacent pixel and the visibility state transition.

71. A hardware device according to claim 69 wherein the SDPS matching algorithm is configured such that there is a fixed and known disparity value change for each visibility state transition across the scan line of the Cyclopaean image such that the disparity value changes are limited.

72. A hardware device according to claim 69 wherein the visibility states of the Cyclopaean image pixels are output as occlusion map data in combination with the disparity map data.

73. A hardware device according to claim 69 wherein the logic of the hardware device is arranged to carry out the following steps for each scan line: performing a forward pass of the SDPS algorithm through the image pixel data; storing predecessors generated during the forward pass in a predecessor array; and performing a backward pass of the SDPS algorithm through the predecessor array based on optimal paths to generate disparity values for the pixels in the scan line of the Cyclopaean image, and wherein the logic of the hardware device comprises control logic for addressing the memory used for storing predecessors in the predecessor array and the control logic is arranged so that the predecessor array is addressed left to right for one scan line and right to left for the next scan line so that predecessor array memory cells are overwritten immediately after they are read by the logic that performs the backward pass of the SDPS algorithm.

74. A hardware device according to claim 73 wherein the logic of the hardware device is further configured to perform an adaptive cost function during the forward pass of the SDPS algorithm such that the predecessors are generated by matching adapted pixel intensities, the adaptation being configured to keep differences in the adjacent pixel intensities to within a predefined range.

75. A hardware device according to claim 65 wherein the logic of the hardware device is reconfigurable or reprogrammable.

76. A hardware device according to claim 65 wherein the hardware device is a Field Programmable Gate Array (FPGA), or an Application Specific Integrated Circuit (ASIC).

77. A computer expansion card for running on a host computer for stereo image matching of a pair of images captured by a pair of cameras, the computer expansion card comprising:
an external device interface for receiving the image pixel data of the pair of images from the cameras;
a hardware device communicating with the external device interface and which is arranged to process and match the image pixel data, the hardware device comprising:
an input or inputs for receiving the image pixel data from the external device interface,
logic that is arranged to implement a SDPS matching algorithm, the SDPS matching algorithm being arranged to calculate an optimal depth profile for corresponding pairs of scan lines of the image pixel data and process the image pixel data to generate disparity map data,
memory for at least a portion of the algorithm data processing, and
an output or outputs for the disparity map data; and
a host computer interface that is arranged to enable communication between the hardware device and the host computer, the hardware device being controllable by the host computer and being arranged to transfer the image pixel data and the disparity map data to the host computer.

78. A computer expansion card according to claim 77 wherein the hardware device further comprises logic that is arranged to implement a distortion removal algorithm and an alignment correction algorithm on the image pixel data prior to processing by the SDPS matching algorithm.

79. A computer expansion card according to claim 77 wherein the SDPS matching algorithm is arranged to generate disparity map data based on a virtual Cyclopaean image that would be seen by a single camera situated midway between a left camera and a right camera, and the SDPS matching algorithm being arranged to select one of a predefined set of visibility states for each pixel in the Cyclopaean image.

80. A computer expansion card according to claim 77 wherein the SDPS matching algorithm is arranged to generate disparity map data for each pixel in the Cyclopaean image, scan line by scan line for each corresponding left and right scan lines of the image pixel data.

81. A computer expansion card according to claim 79 wherein the disparity map data generated by the SDPS matching algorithm comprises a disparity value for each pixel in the Cyclopaean image, and wherein the disparity value for each pixel is calculated based on the visibility state change relative to the adjacent pixel.

82. A computer expansion card according to claim 81 wherein the SDPS matching algorithm is configured so that transitions in the visibility state between adjacent pixels in each scan line of the Cyclopaean image correspond to preset disparity value changes such that the SDPS algorithm is arranged to calculate the disparity value for each pixel based on the disparity value of an adjacent pixel and the visibility state transition.

83. A computer expansion card according to any one of claim 81 wherein the SDPS matching algorithm is configured such that there is a fixed and known disparity value change for each visibility state transition across the scan line of the Cyclopaean image such that the disparity value changes are limited.

84. A computer expansion card according to claim 81 wherein the visibility states of the Cyclopaean image pixels are output by the hardware device as occlusion map data in combination with the disparity map data.

85. A computer expansion card according to claim 81 wherein the logic of the hardware device is arranged to carry out the following steps for each scan line: performing a forward pass of the SDPS algorithm through the image pixel data; storing predecessors generated during the forward pass in a predecessor array; and performing a backward pass of the SDPS algorithm through the predecessor array based on optimal paths to generate disparity values for the pixels in the scan line of the Cyclopaean image, and wherein the logic of the hardware device comprises control logic for addressing the memory used for storing predecessors in the predecessor array and the control logic is arranged so that the predecessor array is addressed left to right for one scan line and right to left for the next scan line so that predecessor array memory cells are overwritten immediately after they are read by the logic that performs the backward pass of the SDPS algorithm.

86. A computer expansion card according to claim 85 wherein the logic of the hardware device is further configured to perform an adaptive cost function during the forward pass of the SDPS algorithm such that the predecessors are generated by matching adapted pixel intensities, the adaptation being configured to keep differences in the adjacent pixel intensities to within a predefined range.

87. A computer expansion card according to claim 77 wherein the logic of the hardware device is reconfigurable or reprogrammable.

88. A computer expansion card according to claim 77 wherein the hardware device is a Field Programmable Gate Array (FPGA), or an Application Specific Integrated Circuit (ASIC).

89. A stereo image matching system for matching a pair of images captured by a pair of cameras comprising:
an input interface for receiving the image pixel data of the pair of images from the cameras;
a hardware device communicating with the input interface and which is arranged to process and match the image pixel data comprising:
an input or inputs for receiving the image pixel data from the input interface,
logic that is arranged to implement a SDPS matching algorithm, the SDPS matching algorithm being arranged to calculate an optimal depth profile for corresponding pairs of scan lines of the image pixel data and process the image pixel data to generate disparity map data,
memory for at least a portion of the algorithm data processing, and
an output or outputs for the disparity map data; and
an output interface to enable communication between the hardware device and an external device and through which the disparity map data is transferred to the external device.

90. A stereo image matching system according to claim 89 wherein the hardware device further comprises logic that is arranged to implement a distortion removal algorithm and an alignment correction algorithm on the image pixel data prior to processing by the SDPS matching algorithm.

91. A stereo image matching system according to claim 89 wherein the SDPS matching algorithm is arranged to generate disparity map data based on a virtual Cyclopaean image that would be seen by a single camera situated midway between a left camera and a right camera, and the SDPS matching algorithm being arranged to select one of a predefined set of visibility states for each pixel in the Cyclopaean image.

92. A stereo image matching system according to claim 89 wherein the SDPS matching algorithm is arranged to generate disparity map data for each pixel in the Cyclopaean image, scan line by scan line for each corresponding left and right scan line of the image pixel data.

93. A stereo image matching system according to claim 91 wherein the disparity map data generated by the SDPS matching algorithm comprises a disparity value for each pixel in the Cyclopaean image, and wherein the disparity value for each pixel is calculated based on visibility state change relative to the adjacent pixel.

94. A stereo image matching system according to claim 93 wherein the SDPS matching algorithm is configured so that transitions in the visibility state between adjacent pixels in each scan line of the Cyclopaean image correspond to preset disparity value changes such that the SDPS algorithm is arranged to calculate the disparity value for each pixel based on the disparity value of an adjacent pixel and the visibility state transition.

95. A stereo image matching system according to claim 93 wherein the SDPS matching algorithm is configured such that there is a fixed and known disparity value change for each visibility state transition across the scan line of the Cyclopaean image such that the disparity value changes are limited.

96. A stereo image matching system according to claim 93 wherein the visibility states of the Cyclopaean image pixels are output by the hardware device as occlusion map data in combination with the disparity map data.

97. A stereo image matching system according to claim 93 wherein the logic of the hardware device is arranged to carry out the following steps for each scan line: performing a forward pass of the SDPS algorithm through the image pixel data; storing predecessors generated during the forward pass in a predecessor array; and performing a backward pass of the SDPS algorithm through the predecessor array based on optimal paths to generate disparity values for the pixels in the scan line of the Cyclopaean image, and wherein the logic of the hardware device comprises control logic for addressing the memory used for storing predecessors in the predecessor array and the control logic is arranged so that the predecessor array is addressed left to right for one scan line and right to left for the next scan line so that predecessor array memory cells are overwritten immediately after they are read by the logic that performs the backward pass of the SDPS algorithm.

98. A stereo image matching system according to claim 97 wherein the logic of the hardware device is further configured to perform an adaptive cost function during the forward pass of the SDPS algorithm such that the predecessors are generated by matching adapted pixel intensities, the adaptation being configured to keep differences in the adjacent pixel intensities to within a predefined range.

99. A stereo image matching system according to claim 89 wherein the logic of the hardware device is reconfigurable or reprogrammable.

100. A stereo image matching system according to claim 89 wherein the hardware device is a Field Programmable Gate Array (FPGA), or an Application Specific Integrated Circuit (ASIC).
